(19) United States
(12) Patent Application Publication
(10) Pub. No.: US 2006/0007795 A1
(43) Pub. Date: Jan. 12, 2006

(54) Interactive dvd applications

(75) Inventors: Eli David, Bet-Yehoshua (IL); Haim Ashar, Munich (DE); Uri Ben-Efraim, Ramat-Efal (IL)

Correspondence Address: WOLF, BLOCK, SCHORR & SOLIS-COHEN LLP, 250 PARK AVENUE, NEW YORK, NY, 10177, US

(73) Assignee: KIPEE-Kid's Interactive Products for Education & Entertainment, Ramat-Efal (IL)

(21) Appl. No.: 10/522,439

(22) PCT Filed: Jul. 17, 2003
(86) PCT No.: PCT/IL03/00589

§ 371 Date: Jan. 18, 2005

(30) Foreign Application Priority Data
Jul. 18, 2002 (IL) IL150808

(51) Int. Cl. G11B 21/08

(52) U.S. Cl. 369/30.03

(57) ABSTRACT

Apparatus for playing an interactive application using a DVD player (24) that generates images on a TV (22) responsive to addressed image data on a DVD (50), the apparatus comprising: a DVD (50) having application images encoded at addressed locations on the DVD; an interface unit (26) comprising an IR transmitter (34), at least one user input device and a processor; a readable memory device (RMD) (52), separate from the DVD (50), encoded with at least one algorithm for determining a DVD image address responsive to activation of the at least one input device by a user; wherein the processor determines an image address responsive to the at least one algorithm and activation of the at least one input device and controls the IR transmitter (34) to transmit an IR signal encoding the address to the DVD player.

### FIELD OF THE INVENTION

The present invention relates to operating an interactive application using a DVD player and a TV.

### BACKGROUND OF THE INVENTION

Interactive applications, such as games and various educational applications that elicit and process user input signals are generally operated on a computer or dedicated game player. These devices usually comprise a suitable input device such as a CD player for inputting game data and algorithms from a CD, a display screen and speakers and at least one user input device such as a keyboard and/or joystick. A processor comprised in the computer or game player generates images on the screen and/or audio signals to stimulate and elicit user activation of the at least one input device and/or to respond to a user input signal from the input device. A given image or sequence of images and/or audio signals is generated responsive to a preceding user input signal or signal and game algorithms.

While most households, and even most relatively poor households, in the developed countries are equipped with a TV and DVD player, computers and game players are less frequently owned than TVs and DVDs.

### SUMMARY OF THE INVENTION

An aspect of some embodiments of the present invention relates to providing a method and apparatus, hereinafter an interaction interface unit (IU), that enables a person to operate, hereinafter also “to play”, an interactive application using a TV and DVD player.

An aspect of some embodiments of the present invention relates to providing an IU that does not require modifying a DVD or a TV so that the IU can be used with the DVD and TV to play an interactive application.

According to an aspect of some embodiments of the invention, the IU controls the DVD player for the purpose of operating an interactive application by transmitting control signals to the DVD player via an IR channel that is normally used to control the DVD player.

According to an aspect of some embodiments of the present invention, an interactive application comprises image and associated audio data, hereinafter collectively “image data” stored on an optionally multimedia DVD. Data and algorithms, hereinafter “operating data”, used for operating the interactive application are stored on a readable memory device (RMD) other than the DVD on which the image and/or audio data is stored. The readable memory device may be any of various devices known in the art such as a CD, DVD, memory stick or smart card. Optionally the RMD is also a writable memory.

An IU in accordance with an embodiment of the invention comprises a processor, apparatus for reading an RMD, at least one user input device such as a keyboard and/or joystick and a suitable IR light source for transmitting IR signals to a DVD. To play an interactive application using the IU, in accordance with an embodiment of the present invention, a user inserts the application's DVD into a DVD player connected to a TV and the application's RMD into the RMD reader of the IU. The user operates the at least one input device to instruct the IU to start the interactive application. Thereafter, during play of the application, the IU processor determines which image or sequence of images and associated audio signals should be presented on the TV responsive to user input signals from the at least one input device and/or operating data on the RMD. The IU then transmits appropriate conventional DVD player IR control signals to the DVD player to control the player to present the required images on the TV.

In general, communication between a DVD player controller and an associated DVD player is one way communication from the controller to the player. A DVD player is not in general equipped to transmit signals to its controller. As a result, an IU, in accordance with an embodiment of the present invention, does not receive feedback signals responsive to control signals that it transmits to a DVD player that it controls that are suitable for monitoring performance of the DVD player.

However, in some embodiments of the invention, images displayed on a TV by a DVD player controlled by an IU are encoded with an optical code, such as a bar-code, that identifies the images and the IU comprises an optical reader, e.g. a bar-code reader, for reading the optical code. The optical code functions as a feedback signal responsive to which the optical reader generates signals that it transmits to the IU processor. To monitor DVD player performance, the processor determines from the signals it receives from the optical reader whether the displayed images are the correct images.

In some embodiments of the invention, an audio portion of the displayed images is encoded with an acoustic code, such as an ultrasound acoustic code. The IU comprises an acoustic sensor that senses the acoustic code and generates signals responsive thereto which it transmits to the processor. The processor uses the received signals to determine if the DVD player is responding properly to the IU's IR control signals.

There is therefore provided, in accordance with an embodiment of the present invention, apparatus for playing an interactive application using a DVD player that generates images on a TV responsive to addressed image data on a DVD, the apparatus comprising: a DVD having application images encoded at addressed locations on the DVD; an interface unit comprising an IR transmitter, at least one user input device and a processor; a readable memory device (RMD), separate from the DVD, encoded with at least one algorithm for determining a DVD image address responsive to activation of the at least one input device by a user; wherein the processor determines an image address responsive to the at least one algorithm and activation of the at least one input device and controls the IR transmitter to transmit an IR signal encoding the address to the DVD player.

Optionally, the interface unit comprises a memory. Optionally, the interface unit stores information responsive to user activation of the at least one input device in the memory. Optionally, the interface unit transmits an address responsive to the stored user activation information.

In some embodiments of the invention the interface unit comprises a clock.

Optionally, the interface unit stores temporal information responsive to user activation of the at least one input device in the memory. Optionally, the interface unit transmits an address responsive to the stored temporal information.

In some embodiments of the invention the processor determines content of an image displayed on the TV responsive to an elapsed time on the clock. Optionally, the interface unit transmits an address responsive to the determined content.

In some embodiments of the invention, the processor determines where on the TV screen an element in an image displayed on the screen is located responsive to elapsed time on the clock. Optionally, the interface unit transmits an address responsive to the location of the element.

In some embodiments of the present invention, images generated on the TV by the DVD comprise optical codes that identify the images. Optionally, the interface unit comprises an optical code reader that transmits signals responsive to the sensed codes to the processor, which processes the signals to determine which image is displayed on the TV.

In some embodiments of the present invention, the DVD is encoded with audio data associated with images encoded on the DVD and when the DVD generates an image on the TV associated with audio data, the DVD controls the TV to generate audio signals responsive to the associated audio data. Optionally, the audio signals comprise an audio code identifying the generated image. Optionally, the interface unit comprises an acoustic sensor that transmits signals responsive to the audio code to the processor, which processes the signals to determine which image is displayed on the TV.

In some embodiments of the present invention, if a determined image does not correspond to an image address transmitted by the interface unit, the interface unit retransmits the address. Optionally, the interface unit comprises a display screen. Optionally, if an image displayed on the TV does not correspond to an image address transmitted by the interface unit, the interface unit generates a signal indicating that there is a malfunction that requires user intervention is required.

In some embodiments of the present invention, the at least one input device comprises a keyboard. In some embodiments of the present invention, the at least one input device comprises a joystick. In some embodiments of the present invention, the RMD comprises a DVD. In some embodiments of the present invention, the RMD comprises a CD. In some embodiments of the present invention, the RMD comprises a memory stick. In some embodiments of the present invention, the RMD comprises a smart card.

### BRIEF DESCRIPTION OF FIGURES

Non-limiting examples of embodiments of the present invention are described below with reference to figures attached hereto, which are listed following this paragraph. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 schematically shows a user preparing to play an interactive educational application using a TV, a DVD and an IU, in accordance with an embodiment of the present invention;

FIGS. 2A-2E schematically show the user shown in FIG. 1 playing the interactive application, in accordance with an embodiment of the present invention; and

FIG. 3 schematically shows the user shown in the previous figures playing an interactive application, which is a game, in accordance with an embodiment of the present invention.

### DETAILED DESCRIPTION OF EXEMPLARY EMBODIMENTS

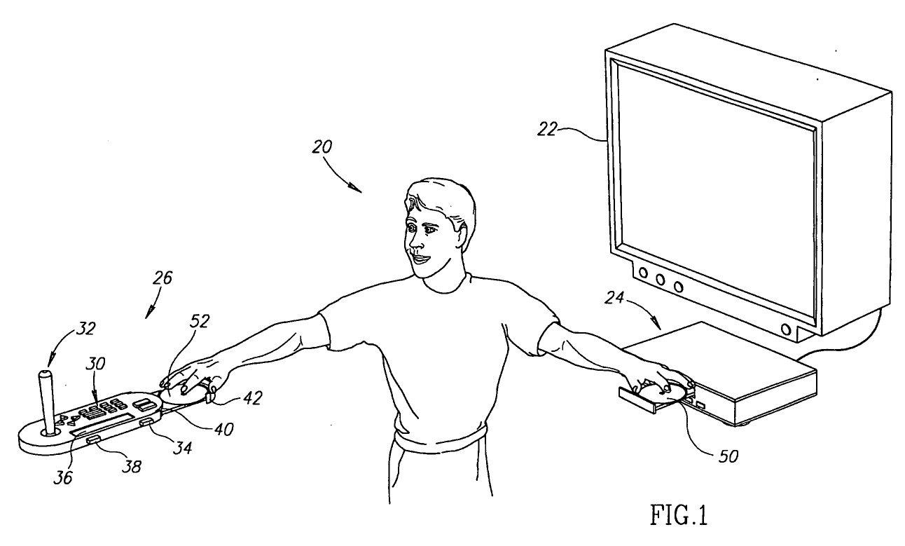

FIG. 1 schematically shows a user 20 preparing to play an interactive application using a TV 22, a DVD player 24 and an interaction interface unit, i.e. an IU 26, in accordance with an embodiment of the present invention.

IU 26 comprises at least one user input device, optionally a keyboard 30 and a joystick 32, an IR transmitter 34 for transmitting IR signals to DVD player 24, a processor and associated memory (not shown) and optionally a display screen 36. Optionally, IU 26 comprises a bar-code reader 38. Data and algorithms, i.e. operating data, that define a given interactive application and are required by the processor comprised in IU 26 to run the application are optionally encoded in a suitable readable memory device, i.e. RMD. Optionally, the RMD is writable. IU 26 is equipped with apparatus for receiving and reading the RMD. An RMD may be any suitable readable memory device known in the art, such as for example a DVD, CD, memory stick or smart card. By way of example, IU 26 is assumed to be equipped to receive RMDs that are CDs and comprises a CD port 40 and reader 42.

User 20 is shown inserting a DVD 50 into DVD player 24 and a CD 52 into IU 26. DVD 50 is encoded with data encoding all images and associated audio tracks that may be required to be displayed and sounded during operation of the interactive application. During operation of the interactive application, the processor in IU 26 determines which images or series of images encoded in DVD 50 should be displayed on TV 22 responsive to operating data encoded in CD 52 and/or how user 20 operates keyboard 30 and joystick 32.

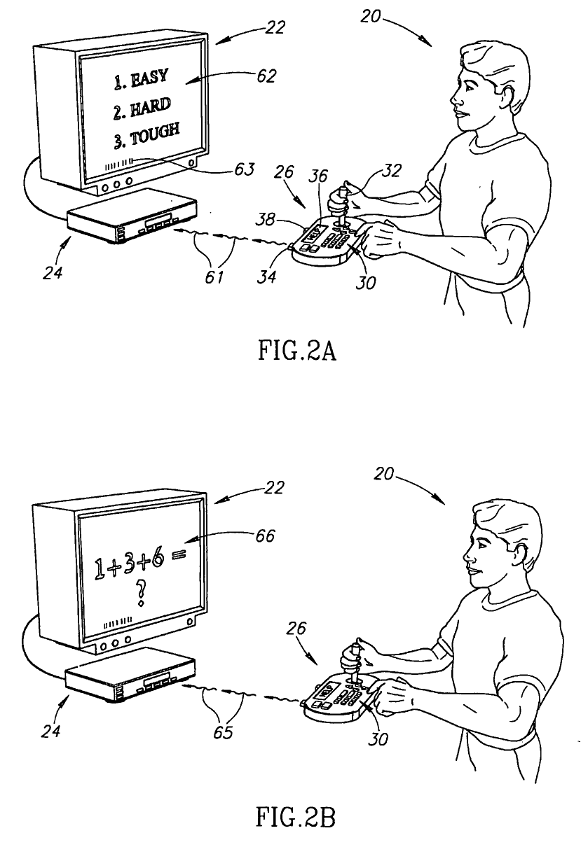

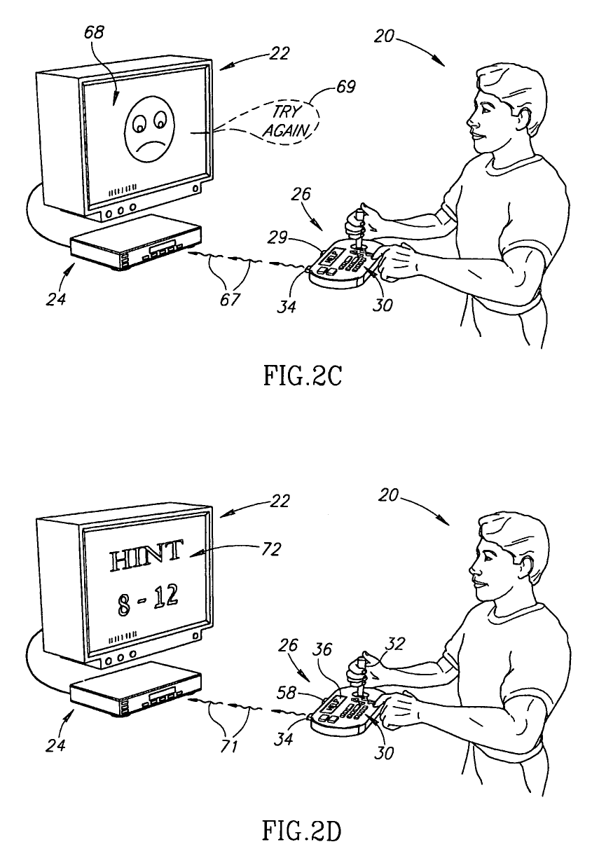

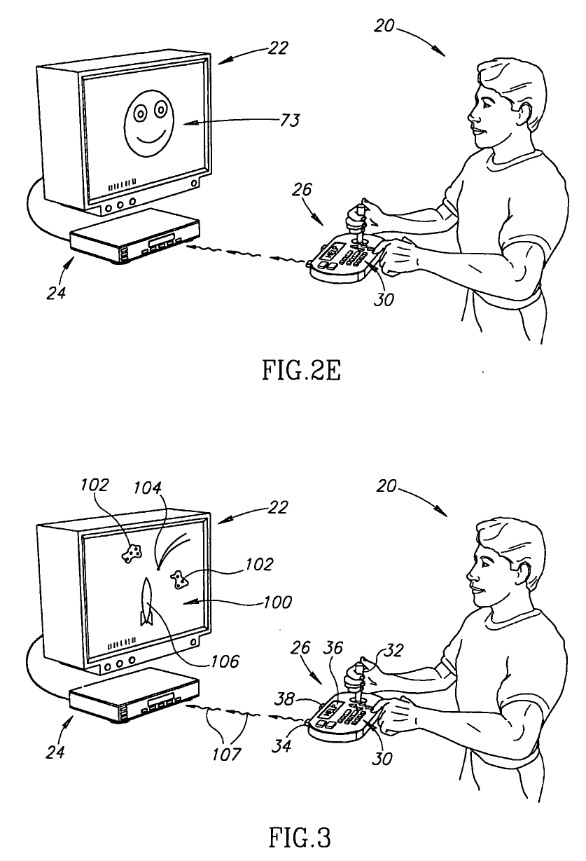

By way of example, the application encoded in CD 52 and DVD 50 is assumed to be an educational application that teaches arithmetic. FIGS. 2A-2C illustrate user 20 taking an arithmetic lesson from the application.

After the user starts the application, optionally by transmitting suitable instructions to IU 26 via keyboard 30, IU 26 displays a message optionally on screen 36 prompting user 20 to log in his name. Thereafter IU transmits IR signals, indicated in FIG. 2A by wavy arrows 61 to DVD player 26 that are encoded with the address or addresses of an introductory sequence of images encoded on DVD 50 (FIG. 1) and a command to display the image sequence. Upon receipt of the IR signals, DVD player 24 accesses the encoded addresses and displays the introductory images on TV 22. The introductory images conclude with an image 62 shown in FIG. 2A that prompts the user to indicate a level of difficulty for the desired arithmetic lesson.

Optionally, image 62 comprises a bar code 63 peculiar to image 62 that identifies the image. Bar-code reader 38 senses bar code 63 and generates a signal responsive thereto that it transmits to the IU processor. The processor processes the received signal to determine whether image displayed on TV 22 is the correct concluding image of the introductory sequence. If bar code 63 indicates that the image is not the correct image, DVD player 24 has malfunctioned and IU 26 optionally attempts to correct the DVD player error by transmitting additional IR signals that instruct the DVD to attempt again to display the introductory images. If after transmitting the additional IR signals bar code reader 38 does not sense the correct bar code, the processor in IU 26 generates a message on display screen 36 indicating that an error, which requires user intervention, has occurred.

In some embodiments of the present invention, a sound track associated with each image from DVD 50 displayed on the screen of TV 22 generates an acoustic signal, such as an ultrasound signal, peculiar to the displayed image that identifies the image. IU 26 comprises an acoustic sensor, (not shown) which senses the acoustic signal and processes the sensed acoustic signal to monitor operation of DVD player 24.

However, in the example shown in FIG. 2A the correct concluding image, image 62, is in fact shown and IU 26 continues running the application and waits for user 20 to choose a level of difficulty. User 20 uses keyboard 30 to indicate that he would like to take the “easy lesson”.

In response to the choice indicated by user 20, the processor in IU 26 transmits an IR signal 65 shown in FIG. 2B to DVD player 24 that encodes an address of an image on DVD 50 that comprises an appropriately easy arithmetic problem. Responsive to IR signal 65, DVD player 24 accesses the encoded address on DVD 50 and displays the image, indicated as image 66 in FIG. 2B, on TV 22. Image 66 comprises an easy arithmetic problem in addition for user 20 to solve. User 20 uses keyboard 30 to key in a number, which he believes to be a correct answer to the problem shown in image 66.

Unfortunately, user 20 is not very good at arithmetic and keys in an incorrect solution. Upon receiving the keyboard signals indicating the incorrect solution, in FIG. 2C the processor in IU 26 controls IR transmitter 34 to transmit IR signals 67 to DVD player 24 that encode an address of an image of a sad face and an associated sound track encoded on DVD. DVD player 24 accesses the image address and controls TV 22 to display the image, indicated as an image 68 and to play the associated sound track “TRY AGAIN” indicated in a bubble 69. Following display of the try again image 68, IU 26 controls DVD player 24 to again present image 66 (FIG. 2B) and awaits the response of user 20.

User 20 repeatedly tries, but fails to solve the problem presented by image 66 and is repeatedly treated to displays of sad face image 68 and exhortations to try again. The processor in IU 26 keeps track of the repeated trials and failings of user 20 and in accordance with an algorithm on CD 52 determines, after a predetermined number of failed attempts, to provide user 20 with a hint. In FIG. 2D, IU 26 transmits IR signals 71 to DVD player 24, which instruct the DVD player to access an address that encodes a “Hint Image” 72 and display the image on TV 22. The hint, which indicates to the user that the answer is between 8 and 12, is sufficient to enable user 20 to come up with the correct solution and key it in on keyboard 30. Upon receiving the correct answer, IU 26 controls DVD player 24 to access and display a happy face image 73 on TV 22.

User 20 is blessed with ample amounts of ambition and endurance and spends an extended period of time solving easy problems in addition, which IU 26 controls DVD player 24 to display on TV 22. During the arithmetic teaching session, the processor in IU 26 determines and stores in the IU memory how many, if any, incorrect solutions are proffered by user 20 for each problem and how long it takes the user to determine the correct solution to the problem. The processor analyzes the accumulated performance statistics for user 20 and determines that his error rate and time to solution of a problem have decreased substantially.

When an exhausted user 20 finally decides to quit the lesson, IU 26 controls DVD player to display a “Congratulations You Have Improved” image on TV 20 and a “Suggestion Image” suggesting that the next lesson be carried out at a more difficult level. The processor stores the performance statistics of user 20 from the lesson and his “log in name” in the associated memory. Optionally, the processor stores the performance statistics and log in name on RMD, i.e. CD 52 (FIG. 1). Optionally, the next time user 20 logs in to take an arithmetic lesson, the processor accesses the stored performance statistics associated with the user's log in name and responsive thereto controls DVD player 24 to display on TV 22 a “You Have Advanced to a Next Level” image, which is encoded in DVD 50. The “Next Level” image is optionally followed by a “Prompt Image” suggesting that he should try the “Hard” problems.

The above illustrated arithmetic lesson is a simplified example of an interactive experience using an IU and more complicated, intricate and/or “dynamic” interactive applications are possible, in accordance with an embodiment of the present invention. For example, after his strenuous mental workout taking arithmetic lessons, user 20 might decide he needs to relax playing a game of “Space Race” and loads an appropriate DVD into DVD player 24 and CD onto his IU 26.

Upon starting the game, IU 26 controls DVD player 24 to show a movie of an interstellar environment in which, for example asteroids, comets, magnetic storms and other “space hazards” stream across the screen of TV 22, optionally from top to bottom. FIG. 3 schematically shows a “snapshot” of Space Race being played by user 20 in which a scene 100 comprising asteroids 102 and an oncoming comet 104 is shown on TV 22.

A space racer 106 is shown against the background of the interstellar environment in scene 100. User 20 controls speed of space racer 106 relative to the flow of space hazards (e.g. asteroids 102 and comet 104) streaming across the screen of TV 22 by moving joystick 32 forwards or backwards. Lateral position of the space ship on the screen is controlled by moving joystick 32 to the left or to the right.

Images, “position images”, of space racer 106 at different locations on the screen of TV 22 are encoded in the overlay layer of the Space Race DVD loaded in DVD player 24. Different positions of space racer 106 on the screen of TV 22 are provided by displaying, responsive to appropriate IR command signals 107 from IU 26, different ones of the position images of the space racer. Motion of space racer 106 relative to the apparent motion of the space racer generated by the streaming of space hazards in the interstellar environment screened on TV 22 is provided by displaying, responsive to appropriate IR signals 107, a sequence of position images of the space ship at different locations on the screen.

The object of the Space Racer game is to travel a longest distance in a shortest time through the interstellar environment displayed on TV 22 while avoiding being demolished by collision with a space hazard. At any time during play, the processor in IU 26 knows the positions of all space hazards on the screen of TV 22 from operational data on the CD in the IU and elapsed time from beginning of play. The processor determines from the displayed position of space racer 106 and the locations of the space hazards if and when the space racer collides with a given space hazard. Upon occurrence of a collision, the processor stores the elapsed time to collision and a travel distance for the space racer in the memory and processes the stored data to provide a performance score for user 20. Optionally, if space racer 106 survives a predetermined time period and/or distance without a collision user 20 is determined to be a Space Race winner.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. Apparatus for playing an interactive application using a DVD player that generates images on a TV responsive to addressed image data on a DVD, the apparatus comprising:
a DVD having application images encoded at addressed locations on the DVD;
an interface unit comprising an IR transmitter, at least one user input device and a processor;
a readable memory device (RMD), separate from the DVD, encoded with at least one algorithm for determining a DVD image address responsive to activation of the at least one input device by a user;
wherein the processor determines an image address responsive to the at least one algorithm and activation of the at least one input device and controls the IR transmitter to transmit an IR signal encoding the address to the DVD player.

2. Apparatus according to claim 1 wherein the interface unit comprises a memory.

3. Apparatus according to claim 2 wherein the interface unit stores information responsive to user activation of the at least one input device in the memory.

4. Apparatus according to claim 3 wherein the interface unit transmits an address responsive to the stored user activation information

5. Apparatus according to claim 2 wherein the interface unit comprises a clock.

6. Apparatus according to claim 5 wherein the interface unit stores temporal information responsive to user activation of the at least one input device in the memory.

7. Apparatus according to claim 6 wherein the interface unit transmits an address responsive to the stored temporal information.

8. Apparatus according to claim 5 wherein the processor determines content of an image displayed on the TV responsive to an elapsed time on the clock.

9. Apparatus according to claim 8 wherein the interface unit transmits an address responsive to the determined content.

10. Apparatus according to claim 5 wherein the processor determines where on the TV screen an element in an image on the screen is located responsive to elapsed time on the clock.

11. Apparatus according to claim 10 wherein the interface unit transmits an address responsive to the location of the element.

12. Apparatus according to claim 1 wherein images generated on the TV by the DVD comprise optical codes that identify the images.

13. Apparatus according to claim 12 wherein the interface unit comprises an optical code reader that transmits signals responsive to the sensed codes to the processor, which processes the signals to determine which image is displayed on the TV.

14. Apparatus according to claim 1 wherein the DVD is encoded with audio data associated with images encoded on the DVD and when the DVD generates an image on the TV associated with audio data, the DVD controls the TV to generate audio signals responsive to the associated audio data.

15. Apparatus according to claim 14 wherein the audio signals comprise an audio code identifying the generated image.

16. Apparatus according to claim 15 wherein the interface unit comprises an acoustic sensor that transmits signals responsive to the audio code to the processor, which processes the signals to determine which image is displayed on the TV.

17. Apparatus according to claim 13 wherein if a determined image does not correspond to an image address transmitted by the interface unit, the interface unit retransmits the address.

18. Apparatus according to claim 17 wherein the interface unit comprises a display screen.

19. Apparatus according to claim 18 wherein if an image displayed on the TV does not correspond to an image address transmitted by the interface unit, the interface unit generates a signal indicating that there is a malfunction that requires user intervention is required.

20. Apparatus according to claim 1 wherein the at least one input device comprises a keyboard.

21. Apparatus according to claim 1 wherein the at least one input device comprises a joystick.

22. Apparatus according to claim 1 wherein the RMD comprises a DVD.

23. Apparatus according to claim 1 wherein the RMD comprises a CD.

24. Apparatus according to clam 1 wherein the RMD comprises a memory stick.

25. Apparatus according to claim 1 wherein the RMD comprises a smart card.
